(19) United States
(12) Patent Application Publication
(10) Pub. No.: US 2024/0171217 A1
(43) Pub. Date: May 23, 2024

(54) NEAR-FIELD COMMUNICATION DATA TRANSMISSION AND ANALYSIS

(71) Applicant: STMICROELECTRONICS INTERNATIONAL N.V., Geneva (CH)

(72) Inventor: Jose MANGIONE, Mougins (FR)

(73) Assignee: STMICROELECTRONICS INTERNATIONAL N.V., Geneva (CH)

(21) Appl. No.: 18/509,013

(22) Filed: Nov. 14, 2023

(30) Foreign Application Priority Data
Nov. 18, 2022 (FR) 2212018

(51) Int. Cl. H04B 5/00; G06K 19/07

(52) U.S. Cl. CPC H04B 5/0031; G06K 19/0723; H04B 5/0037

(57) ABSTRACT

Provided is an electronic system including an electronic device and a reader. The electronic device includes a non-volatile memory; a first NFC module; and a first component adapted to receiving at least one signal sent by a sensor and adapted to converting said signal into digital data. When the electronic device receives said signal said component converts said signal into the data, and then stores said data into said non-volatile memory. The first module is adapted to supplying said reader with said data. The reader includes a second NFC module; and a second component adapted to implementing a digital filtering function. The second module is adapted to receiving said data and said second component is adapted to applying said function to said data.

### TECHNICAL BACKGROUND

The present disclosure generally concerns data transmissions between devices, and more particularly the transmission of data from a sensor to a reader via an electronic device. The present disclosure further concerns data analysis.

### PRIOR ART

It is very current to use sensors to collect data in all types of environment. The recovery and/or the transmission of data obtained by a sensor may be performed by using different types of communication method. Wireless communication methods have the advantage of allowing a simple and fast data transmission without requiring additional equipment.

It would be desirable to be able to improve, at least partly, certain aspects of existing wireless data transmission methods.

### SUMMARY OF THE INVENTION

Provided are wireless data transmission methods.

Provided are methods of data transmission between a sensor and a reader.

Provided are methods of data transmission between a sensor and a reader using a near-field communication.

An embodiment provides an electronic system comprising an electronic device and a reader, said electronic device comprising:
a non-volatile memory;
a first wireless communication module;
a first component adapted to receiving at least one signal sent by a sensor, and adapted to converting said signal into first digital data,
wherein when the electronic device receives said signal said component converts said signal into the first data, and then stores said first data into said non-volatile memory, said first module being adapted to supplying said reader with said first data, and
said reader comprising:
   a second wireless communication module; and
   a second component adapted to implementing a digital filtering function,
   wherein said second module is adapted to receiving said first digital data and said second component is adapted to applying said digital filtering function to said first digital data.

According to an embodiment, said device further comprises said sensor.

According to an embodiment, said non-volatile memory is an EEPROM-type memory.

According to an embodiment, said electronic device communicates with said sensor by using at least one communication channel.

According to an embodiment, said electronic device communicates with said sensor by using at least two communication channels.

According to an embodiment, said first component comprises at least one first analog conversion circuit adapted to extracting second analog data from said signal.

According to an embodiment, said first component comprises at least two first analog conversion circuits adapted to extracting second analog data from said signal.

According to an embodiment, said first component further comprises an analog-to-digital converter circuit adapted to converting said second data into said first data.

According to an embodiment, said first and second wireless communication modules are adapted to implementing a near-field communication.

According to an embodiment, said device further comprises a battery.

Another embodiment provides an electronic device adapted to being the electronic device in the previously-described system.

Another embodiment provides a reader adapted to being the reader in the previously-described system.

Another embodiment provides a method of data transmission between an electronic device and a reader of the previously-described system, comprising the following successive steps:
(a) Reception, by said electronic device, of said signal from said sensor;
(b) Conversion, by said electronic device, of said signal into said first data;
(c) Storage of said first data into said non-volatile memory;
(d) Transmission by a wireless communication of the first data to the reader;
(e) Application of the filtering function to said first data.

According to an embodiment, the wireless communication of step (d) is started before step (a).

According to an embodiment, the reader powers said electronic device, during the near-field communication, with energy.

According to an embodiment, the wireless communication of step (d) is only used to supply energy to the device until the time of step (d), and the reader starts step (d) by sending a control signal to said electronic device by using the wireless communication.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 very schematically shows in the form of blocks an embodiment of an electronic system;

FIG. 2 very schematically shows in the form of blocks a more detailed embodiment of the electronic system of FIG. 1; and

FIG. 3 shows a block diagram illustrating an implementation mode of a near-field communication method implemented by the electronic system of FIGS. 1 and 2.

### DESCRIPTION OF THE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the wireless communication protocols used by the described embodiments are not explained. Indeed, usual wireless communication protocols are compatible with the described embodiments.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, when reference is made to absolute positional qualifiers, such as the terms “front”. “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made, unless specified otherwise, to the orientation of the figures.

Unless specified otherwise, the expressions “around”, “approximately”, “substantially” and “in the order of” signify within 10%, and preferably within 5%.

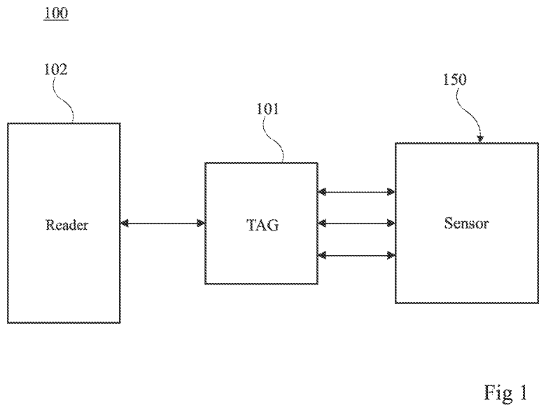

FIG. 1 very schematically shows in the form of blocks an embodiment of an electronic system 100.

Electronic system 100 is adapted to recovering data collected by a sensor 150 (Sensor). System 100 comprises an electronic device 101 (TAG) or tag 101, and a reader 102 (Reader), or terminal 102.

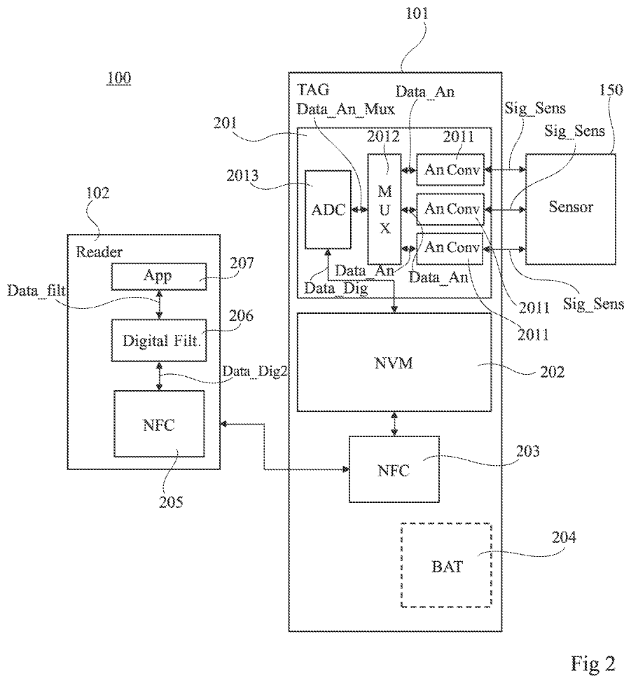

Electronic device 101 is adapted to receiving data from sensor 150. According to an embodiment, electronic device 101 and the sensor are adapted to communication with each other by using one or a plurality of communication channels. These communication channels may be physical communication channels, for example, cables, or may be wireless communication channels, for example, using different communication frequencies. According to a first example, device 101 and sensor 150 are distinct electronic devices. According to an alternative embodiment, device 101 and sensor 150 form part of a same electronic module. Electronic device 101 is further adapted to communicating with reader 102 by using a wireless communication method. Device 101 is described in further detail in relation with FIG. 2.

Reader 102 is adapted to recovering the data of sensor 150 via electronic device 101 by using a wireless communication method. Reader 102 is for example adapted to implementing a circuit and/or a software application using the data of sensor 150. Sensor 102 is described in further detail in relation with FIG. 2.

Sensor 150 may be any type of sensor. According to a first example, sensor 150 may be adapted to capturing temperature or pressure information. According to a second example, sensor 150 may be used in the medical field, for example, to measure and monitor a patient's biological data.

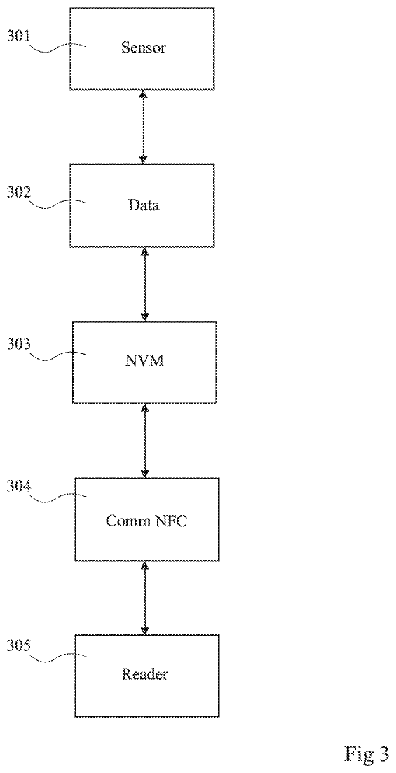

An implementation mode of system 100 is the following. When reader 102 desires to recover data from sensor 150, reader 102 initiates a wireless communication with electronic device 101. Electronic device 101 may then ask data from sensor 150, and then transmit the data received from the sensor to reader 102 by using the wireless communication. According to a variant, electronic device 101 may recover sensor data over time and store them in a memory while waiting for reader 101 to ask for them. Implementation modes of system 100 are described in further detail in relation with FIG. 3.

FIG. 2 very schematically shows in the form of blocks a more detailed embodiment of the system 100 of FIG. 1.

Electronic device 101 comprises:
a component 201 comprising data processing circuits;
a non-volatile memory 202 (NVM);
a wireless communication module 203 (NFC);
a battery 204 (BAT).

The data processing circuit component 201 is adapted to receiving the data signals supplied by sensor 150 over the previously-defined communication channels. As previously mentioned, sensor 150 and electronic device 101 communicate over one or a plurality of communication channels. In FIG. 2, sensor 150 and electronic device 101 communicate by means of three communication channels.

Component 201 comprises analog conversion circuits 2011 (AN Conv) each adapted to receiving a signal Sig_Sens transmitted by a communication channel and to converting this signal Sig_Sens into analog data Data_An. Component 201 more particularly comprises as many analog conversion circuits 2011 as communication channels which are shared by device 101 and sensor 150.

Component 201 further comprises a multiplexer 2012 (MUX) receiving as an input all the outputs of analog conversion circuits 2011 and supplying, as an output, multiplexed analog data Data_An_Mux, that is, analog data Data_An_Mux representative of all the analog data Data_An supplied by circuits 2011.

Component 201 further comprises an analog-to-digital converter 2013 (ADC) adapted to converting the analog data Data_An_Mux supplied by multiplexer 2012 into digital data Data_Dig. Converter 2013 is only used to supply the raw data Data_Dig, that is, by performing a simple conversion of the analog data into digital data, without performing a filtering or data adaptation method. According to an example, analog-to-digital converter 2013 is a sigma/delta-type converter.

Non-volatile memory 202 has the function of storing the digital data Data_Dig supplied by assembly 201, and more particularly, by converter 2013. According to an example, non-volatile memory 202 is an electrically erasable programmable read-only memory (EEPROM), or EEPROM-type memory. Other non-volatile memory types may be used herein.

Wireless communication module 203 is adapted to implementing a wireless communication with reader 102. According to an example, wireless communication module 203 is adapted to implementing a near-field communication (NFC), or NFC communication.

Battery 204 is optional and enables to power with energy electronic device 101. When device 101 comprises no battery, device 101 uses other energy supply means, such as, for example, using the energy supplied by the reader during the implementation of a wireless communication, particularly during an NFC communication.

Reader 102 comprises:
a wireless communication module 205;
a component 206 (Digital Filt.) adapted to implementing a filtering function; and
a circuit 207 (App) adapted to using data collected by sensor 150.

Wireless communication module 205 is adapted to implementing a wireless communication with electronic device 101, and particularly with its wireless communication module 203. According to an example, wireless communication module 205 is adapted to implementing a near field communication (NFC), or NFC communication.

Component 206 is adapted to receiving digital data Data_Dig2 from wireless communication module 205, for example, digital data received from device 101, and to applying thereto a filtering function to supply, as an output, filtered digital data Data_Filt. More particularly, the filtering function enables to perform an elementary processing of the digital data supplied by device 101. According to an example, the filtering function may implement a smoothing or antialiasing function, a bandpass filtering function, a function of noise reduction, for example, at 50 or 60 Hz, or a sampling rate adaptation function.

Circuit 207 receives the filtered digital data Data_Filt from component 206, and is adapted to using them. According to an example, circuit 207 is adapted to implementing a software application using data collected by sensor 150. According to another example, circuit 207 and component 206 are one and the same electronic component.

An advantage of this embodiment is that the implementation of the filtering function by reader 102 enables to relieve electronic device 101 of this function. Indeed, the implementation of a filtering function may be energy- and resource-consuming, and may slow down the data acquisition by the sensor, when the acquisition of data is performed at the time when reader asks for them.

FIG. 3 shows a block diagram illustrating an implementation mode of a method of data transmission within the system 100 described in relation with FIGS. 1 and 2.

At an initial step 301 (block “Sensor”), sensor 150 is implemented to collect the data.

According to a first example, sensor 150 may be configured to collect data autonomously, for example, periodically. According to a second example, sensor 150 may be configured to trigger a data collection on reception of a control signal for example, a control signal originating from device 101. Device 101 may generate this control signal autonomously or on reception of a request from the reader. If device 101 comprises no battery, device 101 may only generate said control signal at the time when a communication is started with reader 102 during which reader 102 supplies energy to device 101.

At a step 302 (block “Data”), successive to step 301, sensor 150 sends the data that it has collected to device 101 by using signal Sig_Sens and the previously-described communication channels. Device 101 then performs the conversion of signal Sig_Sens into digital data Data_Dig. More particularly, device 101 receives signal Sig_Sens via the communication channels and then converts this signal into analog data Data_An_Mux by using analog conversion circuits 2011 and multiplexer 2012, and by then converting them into digital data Data_Dig by using analog-to-digital converter 2013.

At a step 303 (block “NVM”), successive to step 302, digital data Data_Dig are then stored in non-volatile memory 202 while waiting for device 101 to send them to reader 102.

According to a first example, if a wireless communication is not going on yet with reader 102, device 101 may store a plurality of groups of data successively collected by sensor 150 in non-volatile memory 202, within the limit of the storage capacity of non-volatile memory 202. According to a second example, if a communication is already implemented with reader 102, for example, a wireless communication which supplies energy to device 101, then data Data_Dig are temporarily stored in memory 202 and may be directly sent to reader 102 by using this same wireless communication, or from as soon as the reception of a request from reader 102.

At a step 304 (block “Comm NFC”), successive to step 303, a wireless communication is implemented between device 101 and reader 102. As previously mentioned, this wireless communication may have started before step 304, for example at the time of step 301. At step 304, the wireless communication is used by reader 102 to recover the digital data Data_Sig stored in the memory 202 of device 101. For this purpose, reader 102 sends a request to device 101. According to an example, at this step device 101 sends all the digital data Data_Sig stored in memory 202, or only the last data Data_Sig recovered from sensor 150. According to an example, non-volatile memory 202 may further implement a method of protection of the data that it stores, such as for example an authentication method or a data ciphering, to which the reader must be confronted at the time of recovering digital data Data_Sig.

The wireless communication may then be stopped, or may continue if reader 102 desires to recover other data from sensor 102.

At a step 305 (block “Reader”), successive to step 304, reader 102 has recovered data Data_Sig and before being able to use them, for example by using component 207, reader 102 applies filtering function 206 to data Data_Sig. The filtered digital data Data_Filt are then transferred to component 207 to be used.

Various embodiments and variants have been described. Those skilled in the art will understand that certain features of these various embodiments and variants may be combined, and other variants will occur to those skilled in the art.

In particular, a wireless communication only targeting an energy exchange between reader 102 and device 101 may start before the implementation of the step 301 of FIG. 3, and only be used to supply energy to device 101. Thus, after a delay predetermined by the component 206 of reader 102, device 101 is ready to supply reader 102 with the data. Reader 102 then sends a read control signal to device 101 to start the data exchange of the wireless communication.

Finally, the practical implementation of the described embodiments and variations is within the abilities of those skilled in the art based on the functional indications given hereabove.

Electronic system (100) may be summarized as including an electronic device (101) and a reader (102), said electronic device including: a non-volatile memory (202); a first wireless communication module (203); a first component (201) adapted to receiving at least one signal (Sig_Sens) sent by a sensor (150), and adapted to converting said signal (Sig_Sens) into first digital data (Data_Dig), wherein when the electronic circuit (101) receives said signal (Sig_Sens) said component (201) converts said signal (Sig_Sens) into the first data (Data_Dig), and then stores said first data (Data_Dig) into said non-volatile memory (202), said first module (203) being adapted to supplying said reader (102) with said first data (Data_Dig), and said reader (102) including: a second wireless communication module (205); and a second component (206) adapted to implementing a digital filtering function, wherein said second module (205) is adapted to receiving said first digital data (Data_Dig) and said second component (206) is adapted to applying said digital filtering function to said first digital data (Data_Dig).

Said device (101) may further include said sensor (150).

Said non-volatile memory (202) may be an EEPROM-type memory.

Said electronic device (101) may communicate with said sensor (150) by using at least one communication channel.

Said electronic device (101) may communicate with said sensor (150) by using at least two communication channels.

Said first component (201) may include at least one first analog conversion circuit (2011) adapted to extracting second analog data (Data_An) from said signal (Sig_Sens).

Said first component (201) may include at least two first analog conversion circuits (2011) adapted to extracting second analog data (Data_An) from said signal (Sig_Sens).

Said first component (201) may further include an analog-to-digital converter circuit (2013) adapted to converting said second data (Data_An) into said first data (Data_Dig).

Said first and second wireless communication modules may be adapted to implementing a near-field communication.

Said device (101) may further include a battery (204).

Electronic device (101) may be adapted to being the electronic device in the system (100).

Reader (102) may be adapted to being the reader in the system (100).

Method of data transmission between an electronic device (101) and a reader (102) of the system may be summarized as including the following successive steps: (a) reception (302), by said electronic device (101), of said signal (Sig_Sens) from said sensor (150); (b) conversion (302), by said electronic device (101), of said signal (Sig_Sens) into said first data (Data_Dig); (c) storage (303) of said first data (Data_Dig) into said non-volatile memory (202); (d) transmission (304) by a wireless communication of the first data (Data_Dig) to the reader (102); and (e) application (305) of the filtering function to said first data (Data_Dig).

The wireless communication of step (d) may be started before step (a).

The reader (102) may power said electronic device (101), during the near-field communication, with energy.

The reader (102) may power said electronic device (101), during the near-field communication, with energy, and wherein the wireless communication of step (d) is only used to supply energy to the device (102) until the time of step (d), and the reader (102) starts step (d) by sending a control signal to said electronic device (101) by using the wireless communication.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electronic system comprising an electronic device and a reader, the electronic device including:
a non-volatile memory;
a first wireless communication device; and
a first component configured to:
receive at least one signal from a sensor; and
convert the signal into first digital data,
wherein when the electronic device receives the signal the first component converts the signal into the first digital data and stores the first digital data into the non-volatile memory, and
wherein the first wireless communication device is configured to send the first digital data to the reader, and
wherein the reader includes:
a second wireless communication device; and
a second component configured to implement a digital filtering,
wherein the second wireless communication device is configured to receive the first digital data and the second component is configured to apply the digital filtering to the first digital data.

2. The system according to claim 1, wherein the electronic device includes the sensor.

3. The system according to claim 1, wherein the non-volatile memory is an electrically erasable programmable read-only memory (EEPROM)-type memory.

4. The system according to claim 1, wherein the electronic device communicates with the sensor using at least one communication channel.

5. The system according to claim 1, wherein the electronic device communicates with the sensor using at least two communication channels.

6. The system according to claim 4, wherein the first component includes at least one first analog conversion circuit configured to convert the signal to second analog data.

7. The system according to claim 5, wherein the first component includes at least two first analog conversion circuits configured to convert the signal to second analog data.

8. The system according to claim 7, wherein the first component includes an analog-to-digital converter circuit configured to convert the second analog data to the first digital data.

9. The system according to claim 1, wherein the first and second wireless communication devices are configured to communicate using near-field communication.

10. The system according to claim 1, wherein the electronic device includes a battery.

11. An electronic device, comprising:
a non-volatile memory;
a first wireless communication device; and
a first component configured to:
receive at least one signal sent from a sensor; and
convert the signal into first digital data,
wherein when the electronic device receives the signal the first component converts the signal into the first digital data and stores the first digital data in the non-volatile memory, and
wherein the first wireless communication device is configured to send the first digital data to a reader.

12. The electronic device according to claim 11, wherein the first component includes at least one first analog conversion circuit configured to convert the signal to second analog data.

13. The electronic device according to claim 11, wherein the first component includes at least two first analog conversion circuits configured to convert the signal to second analog data.

14. The electronic device according to claim 12, wherein the first component includes an analog-to-digital converter circuit configured to convert the second analog data to the first digital data.

15. The electronic device according to claim 11, wherein the first wireless communication device is configured to communicate using near-field communication.

16. The electronic device according to claim 11, wherein the electronic device includes a battery.

17. A method of data transmission between an electronic device and a reader of a system, comprising:
receiving, by the electronic device, a signal from a sensor;
converting, by the electronic device, the signal into first data;
storing the first data in non-volatile memory;
transmitting, by a wireless communication device of the electronic device, the first data to the reader; and
applying, by the reader, filtering to the first data.

18. The method according to claim 17, wherein transmission, by the wireless communication device, of the first data to the reader is started before reception of the signal from the sensor.

19. The method according to claim 17, wherein the reader powers the electronic device during near-field communication.

20. The method according to claim 18, wherein the reader powers the electronic device during near-field communication, and
wherein the transmitting of the first data to the reader is only used to supply energy to the reader until the transmission of the first data, and
the reader initiates transmission of the first data by sending a control signal to the electronic device using wireless communication.
